(19) United States
(12) Patent Application Publication
(10) Pub. No.: US 2015/0378172 A1
(43) Pub. Date: Dec. 31, 2015

(54) GLASSES WITH INTEGRATED GLASSES CARRIER

(71) Applicant: TI.EMME. TI S.R.L., Melzo (Milano) (IT)

(72) Inventor: Franco TENUTA, INZAGO (MILANO) (IT)

(21) Appl. No.: 14/751,201

(22) Filed: Jun. 26, 2015

(30) Foreign Application Priority Data
Jun. 30, 2014 (IT) MI2014U000211

(51) Int. Cl. G02C 5/14; G02C 5/16; G02C 13/00

(52) U.S. Cl. CPC G02C 5/146; G02C 13/001; G02C 5/16

(57) ABSTRACT

Glasses having a frame for lenses and foldable side arms hinged at one end thereof to the frame. At least one side arm carries a body having an elongated conformation with a first upper portion, at a distance from the side arm, widened with respect to a second lower portion and integral with the side arm, in proximity to an end, of such first portion a seat for an elastic annular element. This elastic annular element suitable to associate with the second portion of the body carried by the side arm in a first work position, but suitable to be arranged partially outside the seat in a second work position but always associated with the side arm. In such second position the annular element being connectable to a button of a garment or a similar element to enable fastening the glasses to this when the glasses are not worn.

### CROSS-REFERENCE TO RELATED APPLICATION

This claims the priority of Italian utility model patent application no. MI2014U000211 filed 30 Jun. 2014, incorporated by reference in its entirety.

### DESCRIPTION

Object of the present invention are glasses according to the preamble of the main claim.

As is known, people who use glasses, in particular for presbyopia, often needs to take them off from the face (for example when the glasses are not used for reading), but to keep the same glasses ready to be grasped for a successive use. For this reason, the user uses a glasses carrier which allows him to obtain this functionality.

Nowadays, on the market, there exist various typologies of glasses carriers, among which one can recite: a small cord to be hanged to the ends of the side arms of the glasses so as to have them around the neck; a ring of various dimensions and different materials, provided with small laces for wearing it around the neck, within which the side arms of the glasses have to be inserted; a ring made of rubber or metal of various types and colors hanged at a brooch for fixing it to an item of clothing, a side arm of the glasses being inserted in said ring for supporting the glasses; a ring analogous to the one of the previously cited example hanged to a body containing a magnet suitable to cooperate at one side of the item of clothing, with a body having another magnet or in ferromagnetic material placed at the other side of the same item of clothing; a conical or frusto-conical body suitable to house the glasses and which can be used with a small cord at the neck, or without small cord hanging it to a button of cloth or provided with a hang element for fixing it to an air vent of the passenger compartment of an automobile.

Al those glasses carriers are elements which are separated from the glasses and which must be associated with these latter so that the user can benefit from their functionalities. From this results a surely unpractical feature, of fixing to the glasses or of use.

A scope of the present invention is that of providing a pair of glasses suitable to cooperate with a glasses carrier which is always available to a user and which is easy and fast to be used for the same user.

Another scope is that of providing a pair of glasses of the cited type wherein the glasses carrier can be used in a safe and efficient way by a user at any moment when this latter takes off his glasses.

These scopes and other ones are reached by a pair of glasses according to the main claim.

For a better understanding of the present invention the following drawings are attached, for a purely illustrative and not limitative purpose, wherein:

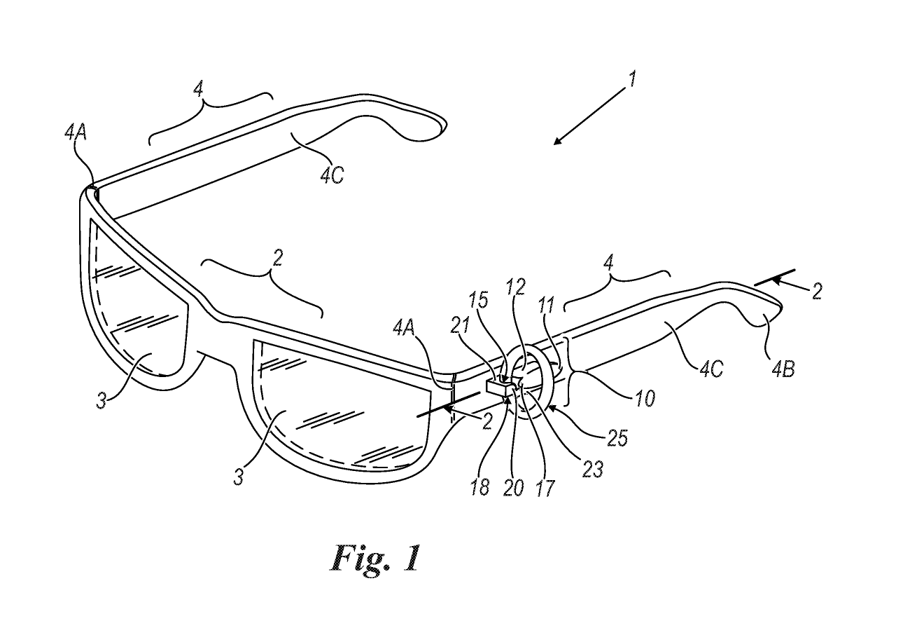

FIG. 1 shows a pair of glasses in position of use obtained according to the invention;

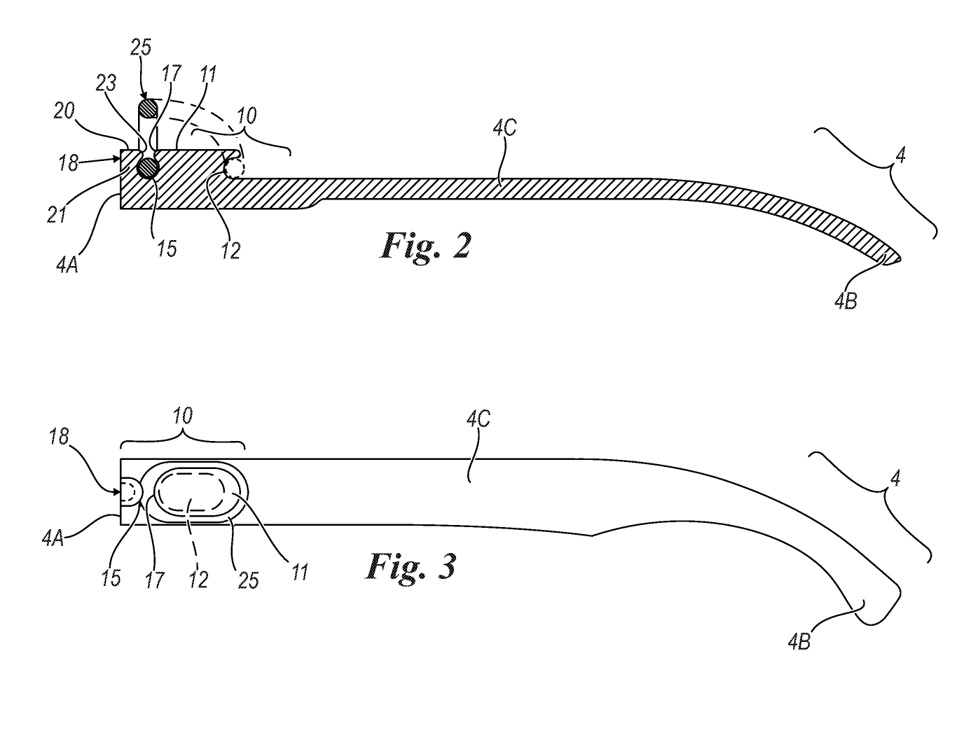

FIG. 2 shows a section view according to the line 2-2 of FIG. 1;

FIG. 3 shows a side view of a side arm of the glasses of FIG. 1, in a different form of use;

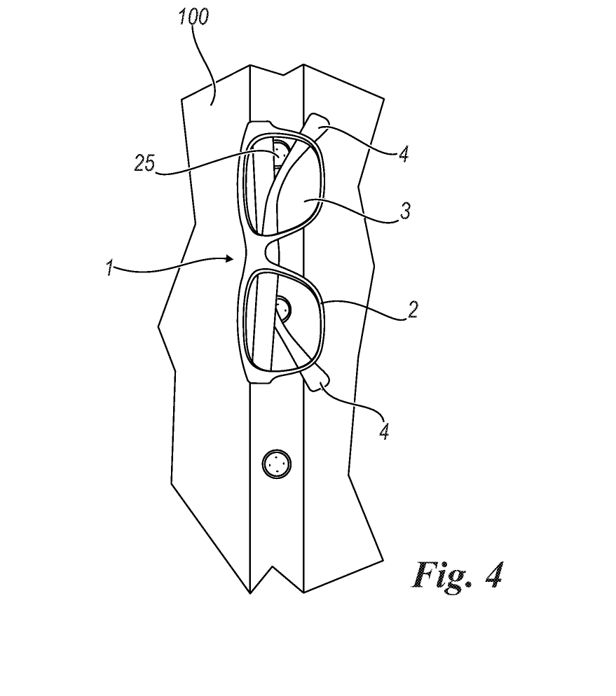

FIG. 4 shows a front side of the glasses of FIG. 1 folded and connected to a button; and

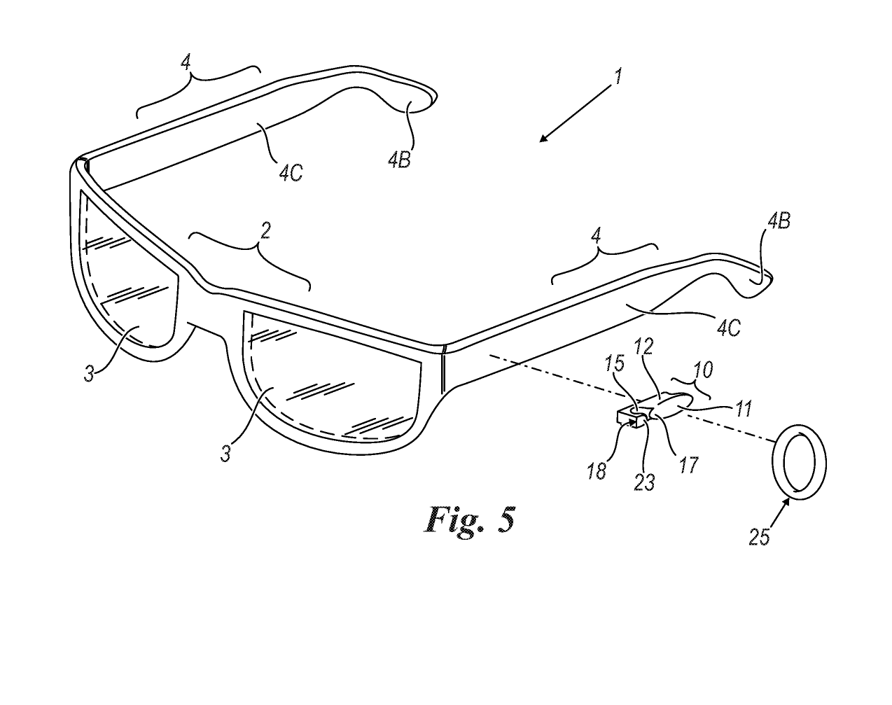

FIG. 5 shows a perspective view of a different embodiment of the glasses of FIG. 1.

Referring to the cited figures, a pair of glasses 1 comprises a frame 2 suitable to support usual lenses 3 and connected to lateral foldable small rods or side arms 4. These latter comprise a first end 4A hinged to the frame 2 and a second free end 4B, as well as a body 4C.

At least the side arms 4 (if not also the frame 2) are made by moulding, for example injection moulding, as is known in the field of glasses production. Such components of these latter can be made of various materials.

According to the invention, at least one side arm 4 carries a body 10 having a lengthened conformation and presenting a first portion or upper portion 11 at a distance from the same body 10 and carried by a second portion or lower portion 12 which is integral with the side arm 4. The first portion 11 is wider than the second one 12 and protrudes above it along its perimeter.

Preferably and advantageously, the body 10 is integral with the side arm 4 and is obtained in a moudling step of this latter.

The body 10 comprises a seat 15, substantially defined by a circular hole, placed at one end 17 of the first portion or upper portion 11 of said body. Such seat 15 is delimitated at one side by a protrusion 18 raising from the side arm 4 (And obviously closed to the abovementioned portion 11), said protrusion having an upper portion 20, facing and preferably coplanar to the above cited portion 11, and a lower portion 21 integral with the side arm 4.

As already said, the body 10 is preferably integral with the side arm 4 and this regards both the portions 11 and 12 and the protrusion 18 (as highlighted in FIG. 2 which represents a substantially longitudinal section of the side arm 4).

Alternatively the body 10 (comprising both the sections 11 and 12 and the protrusion 18) can be autonomously obtained with respect to the side arm (for example by moulding) but fixed (successively to its production) to the side arm 4 in a definitive and not separable manner (for example by means of glue or other mechanical fastening means such as one or more screws). Obviously, such body 10 can also be overmoulded on the side arm 4.

The seat 15 is open in 23 between the abovementioned portions 11 and 20 and such opening 23 enables the forced introduction in the seat of a ring 25 made of elastic material (rubber, anallergic and non toxic silicone or polymer or the like, with high elasticity and breakage strength) having a section slightly smaller than the dimension of the seat 15, but bigger than the dimension of the opening 23 such as to avoid its exit therefrom.

The same ring can have the same or a different color of the glasses and can anyway be substituted following the desire of the user.

The same ring can have two work positions: in a first work position it is arranged around the second portion 12 of the body 10, under the first section 11 which overlaps it protruding from the perimeter of the second portion. Such first work position is shown in FIG. 3.

In a second work position (shown in FIGS. 1 and 2), the ring is placed orthogonally to the side arm 4 so as to protrude laterally from the same. In this position, the ring is separated from the portion 12 and protrudes from the body 10 at the seat 15.

When the ring is in the second work position, folding in an usual way the side arms 4 on the frame 2 it is possible to bring the afore said ring in such a position as to allow its cooperation and safe fixing with a button of an item of clothing 100 (as shown in FIG. 4) or of a coupling element with an usual vent grid of the passenger compartment of an automobile vehicle. This allows to fix the glasses to the same item of clothing or to the dashboard of the vehicle, keeping them always ready to a possible use.

The movement of the ring 25 can be easily obtained with the fingers, the elasticity of the same ring allowing it to be fit on buttons of various dimensions (or diameters), of a shirt, a T-shirt or coat.

It is to be noted that the dimensions of the opening 23 and of the seat 15 are chosen so that the ring can enter in this latter if lengthened, taking benefit of its elastic features (so that its section gets thinner), positioning itself in the seat 15 so that it cannot exit from such seat if lengthened and dragged on purpose.

Differently from the glasses carriers of the known art, which are thus always defined by an additional element separated from the glasses, the present invention provides a pair of glasses equipped with a glasses carrier always associated with them and always available for use.

1. Glasses having a frame carrying lenses and small rods or side arms foldable on the frame, wherein a glasses carrier member is provided integral to at least a side arm and fixed to the side arm, said member allowing the glasses to be associated with and supported at least by a button of an item of cloth or similar support element when they are not used.

2. The glasses according to claim 1, wherein the glasses carrier member comprises a body having a lengthened conformation and presenting a first upper portion, at a distance from the side arm, overlapping and protruding from a lower portion integral to the side arm, said body presenting a seat for an elastic ring element suitable to have a first work position wherein the elastic ring element is associated with said second lower portion of said body, and a second work position wherein such elastic ring element protrudes from the side arm, but still being integral thereto, so as to be connectable to the button or similar support element.

3. The glasses according to claim 2, wherein said seat is defined by said first and second portion of said body and by a protrusion in proximity thereof and always part of said body, said seat having a dimension slightly bigger than the dimension of a transverse section of the elastic ring element and being open, said opening being smaller than the aforesaid section of the aforesaid ring element.

4. The glasses according to claim 3, wherein the body of the glasses carrier member is integral with the side arm.

5. The glasses according to claim 4, wherein the side arm and said glasses carrier member are obtained through moulding.

6. The glasses according to claim 3, wherein said body of the glasses carrier member is fixed in a non separable manner to the side arm.

7. The glasses according to claim 2, wherein said ring element is made of a material chosen from the group consisting of rubber, non toxic and anallergic silicone, polymeric material, said material having a high elasticity and breakage strength.

8. The glasses according to claim 2, wherein said ring element is colored.
